(19) United States
(12) Patent Application Publication
(10) Pub. No.: US 2011/0074064 A1
(43) Pub. Date: Mar. 31, 2011

(54) IMPRINT APPARATUS AND PRODUCT MANUFACTURING METHOD

(75) Inventor: Nozomu Hayashi, Utsunomiya-shi (JP)

(73) Assignee: CANON KABUSHIKI KAISHA, Tokyo (JP)

(21) Appl. No.: 12/889,202

(22) Filed: Sep. 23, 2010

(30) Foreign Application Priority Data
Sep. 30, 2009 (JP) 2009-228654
Aug. 26, 2010 (JP) 2010-189990

(51) Int. Cl. B29C 59/02

(52) U.S. Cl. 264/293; 425/150

(57) ABSTRACT

An imprint apparatus forms patterns in a plurality of shot regions on a substrate by repeating an imprint cycle in which a pattern is formed in one shot region on the substrate by curing a resin while an original and the resin are in contact with each other. The apparatus comprises a detector configured to detect a mark formed on the substrate, and a controller configured to execute overlay measurement, in which the controller causes the detector to detect the mark, and obtains an overlay error that is a shift between a pattern formed on a given layer on the substrate and a pattern newly formed on a layer on or above the given layer, between successive imprint cycles.

### BACKGROUND OF THE INVENTION

1. Field of the Invention

The present invention relates to an imprint apparatus that forms a pattern by curing a resin while an original is pressed against the resin, and a method of manufacturing a product using the same.

2. Description of the Related Art

A photolithographic technique has conventionally been employed to manufacture devices such as semiconductor devices. In the photolithographic technique, the pattern of an original is transferred by an exposure apparatus onto a resist (photosensitive material) applied on a substrate, and the resist is developed, thereby forming a resist pattern on the substrate. Using the resist pattern as a mask, the layer under this pattern is etched, or ions are implanted into the substrate.

Another known technique for manufacturing devices such as semiconductor devices is an imprint technique that applies a resin onto a substrate, and cures the resin while an original is pressed against the resin (Japanese Patent Laid-Open No. 2007-165400). The imprint technique does not require a development process because a pattern corresponding to a resist pattern is formed on the substrate by curing the resin.

### SUMMARY OF THE INVENTION

Because an imprint apparatus presses an original against a substrate or a resin applied on it, a pattern formed on the substrate may shift in position from a target pattern or deform due to deformation of the original and substrate. Therefore, a shift between a pattern formed on a given layer on the substrate and that newly formed on a layer on or above the given layer, that is, an overlay error is likely to occur. In view of this, it may be undesirable for an imprint technique to use a method of measuring an overlay error, as adopted for a photolithographic technique, that is, a method of exposing all shot regions on a substrate, developing the substrate by a developing apparatus, and thereafter executing overlay measurement. That is, when a method of measuring an overlay error in a photolithographic technique is applied to an imprint technique, a time lag from when an overlay error occurs until it is corrected is so long that substrates with overlay errors that fall outside a tolerance may be produced in large quantities.

According to another aspect, it may be useful to quickly detect the occurrence of an overlay error immediately after the original is exchanged or in the first one of lots each including a plurality of substrates.

The present invention has been made in consideration of the above-described problem recognized by the inventor of the present invention, and provides a technique useful in quickly detecting the occurrence of an overlay error that falls outside a tolerance.

One of the aspects of the present invention an imprint apparatus which forms patterns in a plurality of shot regions on a substrate by repeating an imprint cycle in which a pattern is formed in one shot region on the substrate by curing a resin while an original and the resin are in contact with each other, the apparatus comprising a detector configured to detect a mark formed on the substrate, and a controller configured to execute overlay measurement, in which the controller causes the detector to detect the mark, and obtains an overlay error that is a shift between a pattern formed on a given layer on the substrate and a pattern newly formed on a layer on or above the given layer, between successive imprint cycles.

Further features of the present invention will become apparent from the following description of exemplary embodiments with reference to the attached drawings.

### BRIEF DESCRIPTION OF THE DRAWINGS

FIG. 1 is a view showing the schematic arrangement of an imprint apparatus according to an exemplary embodiment of the present invention;

FIG. 2 is a view illustrating the arrangement of shot regions;

FIG. 3 is a view illustrating marks for overlay measurement;

FIG. 4 is a flowchart illustrating an imprint sequence; and

FIG. 5 is a flowchart illustrating another imprint sequence.

### DESCRIPTION OF THE EMBODIMENTS

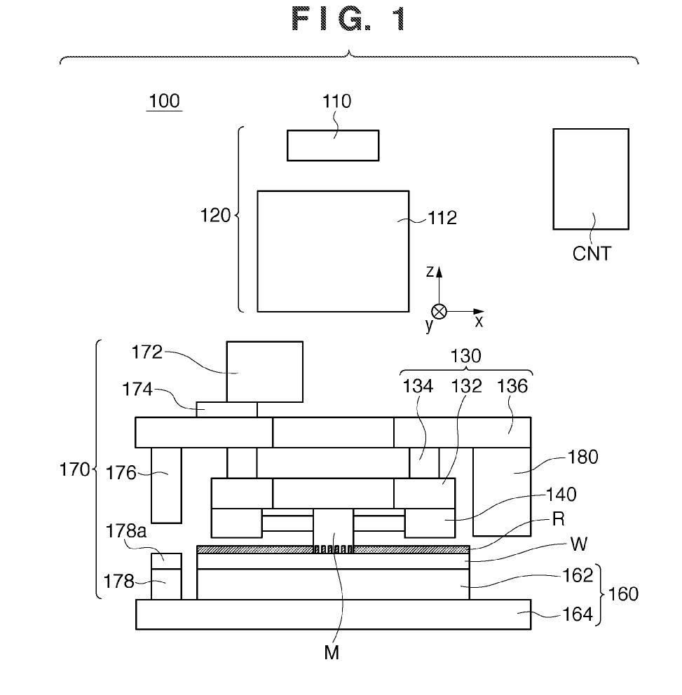

An imprint apparatus according to an exemplary embodiment of the present invention will be described with reference to FIG. 1. A case in which the present invention is applied to an UV (ultraviolet) photo-curing type imprint apparatus which cures a resin by irradiating it with UV light will be taken as an example herein. However, the present invention is also applicable to an imprint apparatus which cures a resin by irradiating it with light in another wavelength range, and an imprint apparatus which cures a resin using another energy (for example, heat).

An imprint apparatus 100 according to the exemplary embodiment of the present invention is configured to form patterns in a plurality of shot regions on a substrate by repeating an imprint cycle. One imprint cycle means herein the cycle in which a pattern is formed in one shot region on a substrate by curing a resign while the resin and an original are in contact with each other. The imprint apparatus 100 can include, for example, a curing unit 120, original operation mechanism 130, original shape correcting mechanism 140, substrate driving unit 160, alignment mechanism 170, and controller CNT.

The curing unit 120 cures a resign (resist) R by irradiating it with ultraviolet light via an original (mold) M. In this embodiment, the resin R is an ultraviolet-curable resin. The curing unit 120 includes, for example, a light source unit 110 and optical system 112. The light source unit 110 can include a light source, such as a halogen lamp, which emits ultraviolet light (for example, the i- or g-line), and an elliptical mirror, which converges the light emitted by the light source. The optical system 112 can include, for example, a lens and aperture for guiding light for curing the resin R to the resin R within shot regions. The aperture is used for angle of view control, and peripheral light shielding. The angle of view control allows illumination of only a target shot region, and the peripheral light shielding allows prevention of ultraviolet light from entering portions that fall outside the outer shape of a substrate (wafer) W. The optical system 112 may include an optical integrator to uniformly illuminate the original M. The light whose range is defined by the aperture strikes the resin R on the substrate W via an imaging system and the original M.

A microstructure pattern to be transferred is formed on the original M. To transmit ultraviolet light for curing the resin R, the original M is made of a material transparent for the wavelengths of ultraviolet light, such as quartz. The original M can be conveyed by an original conveyance mechanism (not shown). The original conveyance mechanism includes, for example, a conveyance robot having a chuck such as a vacuum chuck.

The original operation mechanism 130 can include, for example, an original chuck 132 which holds the original M, an original driving mechanism 134 which drives the original M by driving the original chuck 132, and an original base 136 which supports the original driving mechanism 134. The original driving mechanism 134 includes a positioning mechanism which controls the position of the original M on six axes, and a mechanism which presses the original M against the substrate W or the resin R on it, or separates the original M from the cured resin R. The six axes herein refer to the X-, Y-, and Z-axes in an X-Y-Z coordinate system that uses the support surface (this is parallel to a surface which supports the substrate W) of the original chuck 132 as the X-Y plane, and a direction perpendicular to the X-Y plane as Z-axis; and the axes of rotation about the respective axes.

The original shape correcting mechanism 140 can be mounted on the original chuck 132. The original shape correcting mechanism 140 can correct the shape of the original M by, for example, pressurizing the original M from the circumferential direction using a cylinder actuated by a fluid such as air or oil. Alternatively, the original shape correcting mechanism 140 includes a temperature controller, which controls the temperature of the original M, and corrects the shape of the original M by controlling the temperature of the original M. The substrate W may deform (typically, expand or contract) through a process such as annealing. The original shape correcting mechanism 140 corrects the shape of the original M so that the overlay error falls within a tolerance, in accordance with the characteristics of such deformation of the substrate W.

The resin R is applied onto the substrate W by a dispense mechanism 180. A resin is applied by the dispense mechanism 180 to a target shot region in which a pattern is formed. The original M is pressed against the resin, and the resin cures upon being irradiated with ultraviolet light in this state. The same process is executed for the next shot region. The dispense mechanism 180 can include, for example, a tank which stores a resin, a nozzle which discharges the resin, supplied from the tank through a supply channel, to the substrate, a valve placed in the supply channel, and a supply amount controller. The supply amount controller typically controls the amount of resin, to be supplied to the substrate W, by controlling the valve so that the resin is applied to one shot region by one resin discharge operation.

The substrate driving unit 160 can include, for example, a substrate chuck 162 which holds the substrate W, a substrate stage 164 which drives the substrate W by driving the substrate chuck 162, and a stage driving mechanism (not shown). The stage driving mechanism can include a positioning mechanism which controls the position of the substrate W by controlling the position of the substrate stage 164 on the above-mentioned six axes.

The alignment mechanism 170 can include, for example, an alignment scope 172, an alignment stage mechanism 174, an off-axis scope (OAS) 176, and a reference mark table 178 which mounts a reference mark 178a. The alignment scope 172 can include an AAS (Automatic Adjustment Scope) which aligns the original M and each shot region on the substrate W. The alignment scope 172 detects the positions of alignment marks formed on the original M, and that of the reference mark 178a, via the original M. The alignment stage mechanism 174 is mounted on the original base 136, and positions the alignment scope 172. A baseline length can be obtained by detecting the position of the reference mark 178a by the off-axis scope 176. The positions of alignment marks formed on the substrate W are detected with reference to the reference mark 178a based on the baseline length. The reference mark 178a is used to measure the positional relationships among the off-axis scope 176, substrate stage 164, and original M.

The controller CNT executes overlay measurement between successive imprint cycles. In this overlay measurement, the alignment marks formed on the substrate W are detected by the off-axis scope (detector) 176, and an overlay error is obtained based on the detection result. The overlay error is a shift between a pattern formed on a given layer on the substrate W and that newly formed on a layer on or above the given layer. In this embodiment, the controller CNT additionally controls imprint operations (resin application, original pressing against the resin, and resin curing).

Although not shown, the imprint apparatus 100 additionally includes a surface plate and an anti-vibration device (damper). The surface plate supports the entire imprint apparatus 100, and forms a reference plane when the substrate stage 164 moves. The anti-vibration device supports the surface plate by removing vibration from the floor.

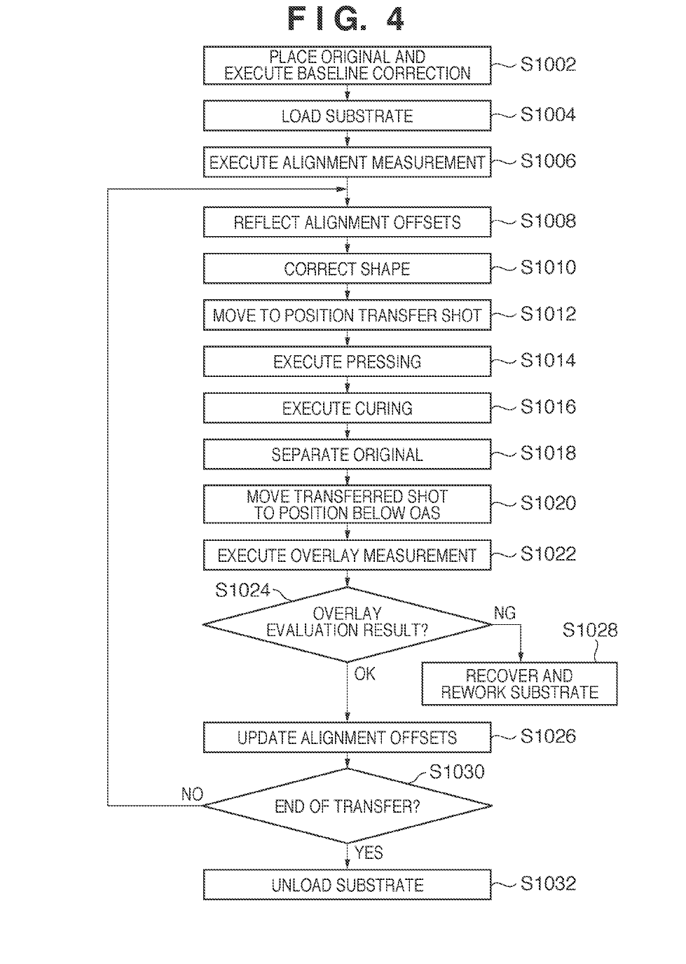

The operation of the imprint apparatus 100 will be described below with reference to FIG. 4. In this embodiment, the controller CNT controls this operation. First, in step S1002, an original M is conveyed onto the original chuck 132, positioned, and held by the original chuck 132. Also in step S1002, baseline correction (baseline measurement) is executed. The baseline correction can be executed in the following way. First, the positional relationship between the reference mark 178a mounted on the reference mark table 178, and the alignment marks on the original M is measured via the original M using the alignment scope 172. Next, the reference mark 178a is moved to a position below the off-axis scope 176 by driving the substrate stage 164, and the position of the reference mark 178a is measured by the off-axis scope 176. A baseline length is obtained based on these measurement results.

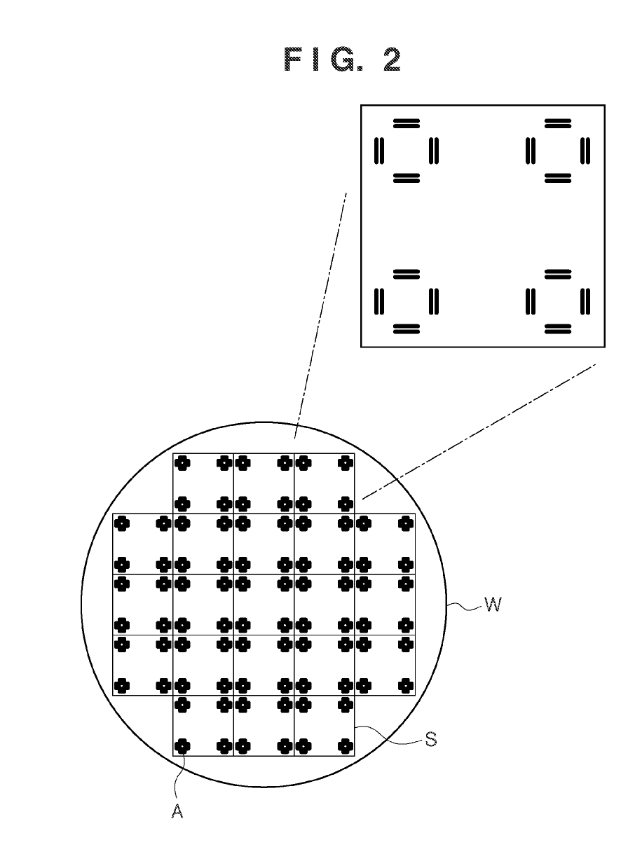

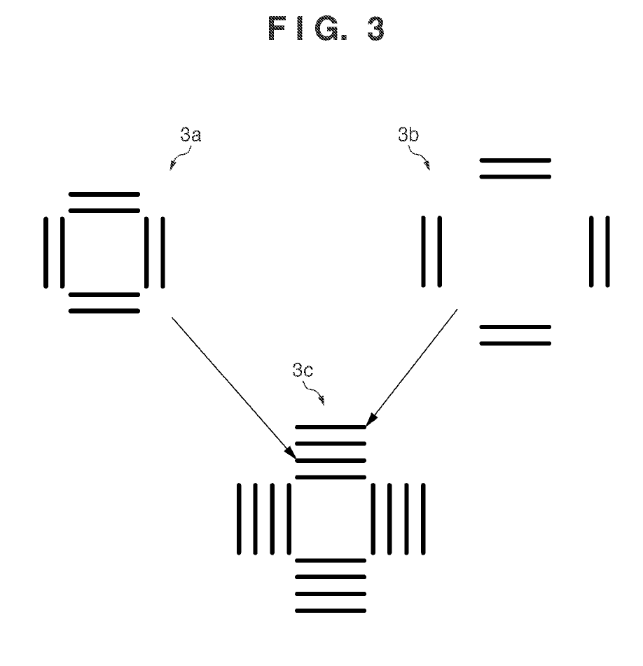

In step S1004, the substrate W is loaded onto the substrate chuck 162 by a conveyance mechanism (not shown), and held by the substrate chuck 162. In this case, the substrate W has at least one pattern having already been formed on it, together with alignment marks. FIG. 2 illustrates the alignment marks formed on the substrate W. A plurality of shot regions S are formed on the substrate W, and an alignment mark A is formed in each shot region S. Although not shown in FIG. 2, marks for measuring an overlay error, as illustrated in FIG. 3, are also formed on each layer on the substrate W. Reference numeral 3a denotes a mark formed by imprinting onto a given layer; 3b, a mark formed by imprinting onto a layer under the given layer; and 3c, a composite mark (that is, a superimposed mark). The sequence from the substrate loading (step S1004) to the substrate unloading (step S1032) can be defined as one imprint sequence. The mark 3b can be formed on a given layer on the substrate in the last or previous imprint sequence, and the new mark 3a can be formed on a layer on the given layer in the current imprint sequence. The composite mark 3c is thus formed. A shift between the marks 3a and 3b in the composite mark 3c can be measured as an overlay error. A plurality of marks 3c each including marks 3a and 3c are preferably arranged in one shot region.

In step S1006, alignment measurement is executed in accordance with the global alignment scheme. More specifically, the positions of preset alignment marks A on the substrate W are measured using the off-axis scope 176, and pieces of arrangement information (for example, the coordinates, rotation, and magnification) of each shot region S on the substrate W are determined based on the measurement result. In step S1008, preset alignment offsets (these are updated in step S1026) are reflected on, for example, the coordinates, rotation, and magnification of a shot region to undergo an imprint cycle (resin application, original pressing, and resin curing). The above-mentioned alignment offsets can include, for example, the magnification, a shift, and rotation of the original M, and those of the entire substrate or a shot region, and high-order components of these characteristics. The reflection means herein correction of the coordinates, rotation, and magnification of a shot region. In step S1010, the shape of the original M is corrected by the original shape correcting mechanism 140 to correct its magnification as needed.

In step S1012, the substrate stage 164 is driven so that the shot region to undergo an imprint cycle is positioned below the dispense mechanism 180, and a resin is applied to the shot region. The substrate stage 164 is further driven so that the shot region is positioned below the original M. In step S1014, the original operation mechanism 130 lowers the original M to press the original M against the substrate W or the resin. At this time, instead of driving the original M, the substrate W may be driven to press the original M against the resin. The pressing load can be controlled using a load sensor built in the original driving mechanism 134. In step S1016, the resin is cured by irradiating it with ultraviolet light via the original M using the curing unit 120. In step S1018, the original operation mechanism 130 lifts the original M to separate the original M from the cured resin. At this time, instead of driving the original M, the substrate W may be driven.

In step S1020, the substrate stage 164 is driven so that the composite mark 3c illustrated in FIG. 3 is positioned below the off-axis scope (detector) 176. In step S1022, the controller CNT executes overlay measurement. More specifically, the controller CNT causes the off-axis scope 176 to obtain a shift between the marks 3a and 3b in the mark 3c as an overlay error.

In step S1024, it is determined whether the overlay error falls within a tolerance. If the overlay error falls outside the tolerance, the substrate is unloaded (recovered) and reworked in step S1028. In contrast, if the overlay error falls within the tolerance, the above-mentioned alignment offsets are updated based on the overlay error. Note that when the magnification and rotation of the entire substrate are updated as alignment offsets, these alignment offsets are updated based on overlay errors measured in a plurality of shot regions.

In step S1030, it is determined whether all shot regions on the substrate have undergone imprinting. If a shot region to undergo imprinting remains, the process returns to step S1008, in which the above-mentioned process is repeated for the next shot region.

In contrast, if all shot regions have undergone imprinting, the substrate W is unloaded from the substrate chuck 162 by a conveyance mechanism (not shown) in step S1032.

In this manner, the occurrence of an overlay error can be quickly detected immediately after this occurrence by executing overlay measurement between successive imprint cycles. This is very useful for an imprint apparatus that generates an overlay error that may fluctuate for each imprint cycle due to, for example, deformation, damage, or deterioration of the original upon pressing it against the substrate.

In the above-described embodiment, shot regions are positioned by global alignment. However, in the pressing process (step S1014), die-by-die alignment in which alignment measurement and positioning correction are executed for each shot region may be executed.

Also, in an example shown in the above-described embodiment, resign application, original pressing, and resin curing are performed for each shot region, that is, one imprint cycle includes resin application, original pressing, and resin curing. However, original pressing and resin curing may be sequentially performed for a plurality of regions after a resin is applied to the plurality of shot regions. In this case, each imprint cycle includes original pressing and resin curing, but does not include resin application.

Moreover, in the above-described embodiment, overlay measurement is performed using the off-axis scope 176. However, overlay measurement may be performed using the alignment scope 172 or another measurement device.

In the above-described embodiment, overlay measurement and alignment offset updating (steps S1020, S1022, and S1024) are executed for each imprint cycle (imprinting to a shot region), as shown in the above-described embodiment. However, to improve the throughput, the controller CNT may execute overlay measurement only immediately after the first imprint cycle after the original is exchanged. In such control, the occurrence of an overlay error that exceeds an allowable value cannot be detected after overlay measurement is cancelled. However, after the original is exchanged, the occurrence of an overlay error can be detected before the completion of imprinting to all shot regions on the substrate.

Alternatively, the controller CNT may execute overlay measurement only for the first substrate in a lot including a plurality of substrates. In such control, the occurrence of an overlay error that exceeds an allowable value cannot be detected after overlay measurement is cancelled. However, the occurrence of an overlay error can be detected before the completion of imprinting to all shot regions on the first substrate in the lot.

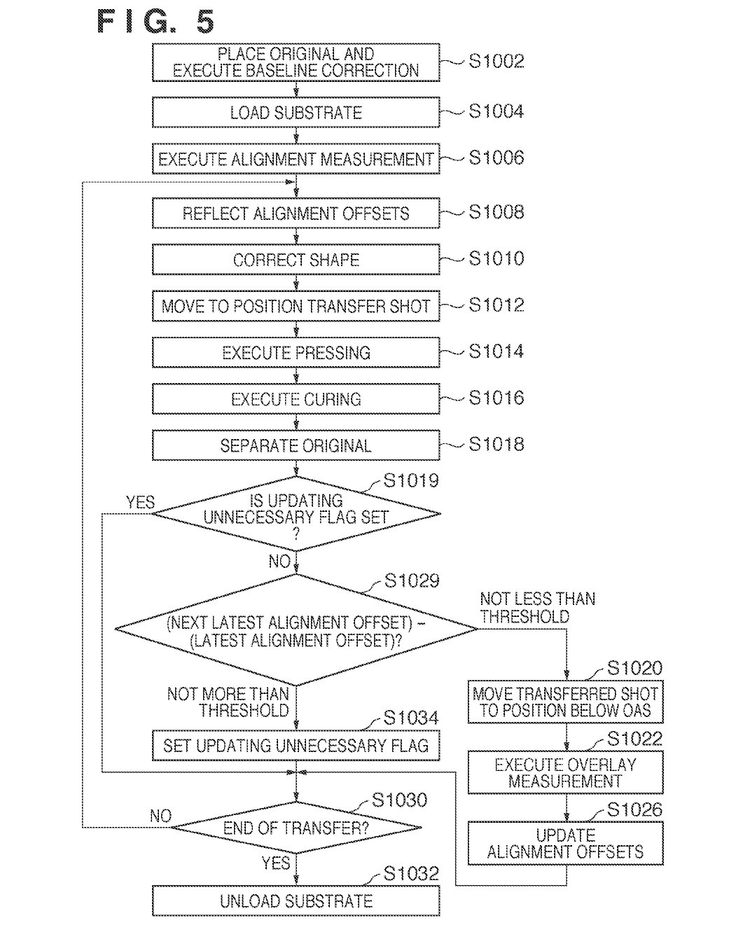

The controller CNT may control the series of processes so as not to execute overlay measurement after the difference between an overlay error obtained by the latest overlay measurement and that obtained by the next latest overlay measurement falls below a threshold. FIG. 5 shows an example of such control. Note that the same reference numerals as in FIG. 4 denote the same steps in FIG. 5. Details different from the control shown in FIG. 4 will be described below.

Note that the following description assumes that an updating unnecessary flag is reset in the initial state. Subsequent to step S1018, it is determined in step S1019 whether the updating unnecessary flag is set. If the updating unnecessary flag is set, the process advances to step S1030; otherwise, the process advances to step S1029.

In step S1029, it is determined whether the difference between the latest alignment offset and the next latest alignment offset falls below a threshold. If the difference falls below the threshold, the updating unnecessary flag is set in step S1034. The fact that the difference between the latest alignment offset and the next latest alignment offset falls below a threshold means that the difference between an overlay error obtained by the latest overlay measurement and that obtained by the next latest overlay measurement falls below an allowable value. The state in which the updating unnecessary flag is set means that alignment offset updating is unnecessary, that is, overlay measurement is unnecessary.

If it is determined in step S1029 that the difference does not falls below the threshold, this means that alignment offset updating is necessary, that is, overlay measurement is necessary. In this case, steps S1020 (substrate movement for overlay measurement), S1022 (overlay measurement), and S1026 (alignment offset updating) mentioned above are executed.

While the updating unnecessary flag is set, steps S1020 (substrate movement for overlay measurement), S1022 (overlay measurement), and S1026 (alignment offset updating) are skipped. That is, overlay measurement is executed between successive imprint cycles until the difference between an overlay error obtained by the latest overlay measurement and that obtained by the next latest overlay measurement falls below the allowable value. After that, overlay measurement is skipped.

Although an embodiment of the present invention has been described above, the present invention is not limited to the embodiment, and various modifications and changes can be made without departing from the scope of the present invention.

### [Product Manufacturing Method]

A method of manufacturing a device (a semiconductor integrated circuit device, a liquid crystal display device, or MEMS) as a product includes a step of transferring (forming) a pattern onto a substrate (for example, a wafer, a glass plate, or a film-like substrate) using the above-mentioned imprint apparatus. The manufacturing method can also include a step of etching the substrate onto which the pattern is transferred. Note that if other products such as a patterned medium (recording medium) or an optical element are manufactured, the manufacturing method can include other steps of processing the substrate onto which the pattern is transferred, in place of the etching step.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-228654 filed Sep. 30, 2009 and No. 2010-189990 filed Aug. 26, 2010, which are hereby incorporated by reference herein in their entirety.

What is claimed is:

1. An imprint apparatus which forms patterns in a plurality of shot regions on a substrate by repeating an imprint cycle in which a pattern is formed in one shot region on the substrate by curing a resin while an original and the resin are in contact with each other, the apparatus comprising:
a detector configured to detect a mark formed on the substrate; and
a controller configured to execute overlay measurement, in which the controller causes the detector to detect the mark, and obtains an overlay error that is a shift between a pattern formed on a given layer on the substrate and a pattern newly formed on a layer on or above the given layer, between successive imprint cycles.

2. The apparatus according to claim 1, further comprising
a substrate chuck configured to hold the substrate,
wherein the controller executes the overlay measurement between the successive imprint cycles during a period from when the substrate is loaded onto the substrate chuck until the substrate is unloaded from the substrate chuck.

3. The apparatus according to claim 1, wherein the controller executes the overlay measurement only immediately after the first imprint cycle after the original is exchanged.

4. The apparatus according to claim 1, wherein the controller executes the overlay measurement only for the first substrate in a lot including a plurality of substrates.

5. The apparatus according to claim 1, wherein the controller executes the overlay measurement between the successive imprint cycles until a difference between an overlay error obtained by the latest overlay measurement and an overlay error obtained by the next latest overlay measurement falls below an allowable value.

6. The apparatus according to claim 1, wherein the controller causes the detector to detect marks formed on different layers on the substrate.

7. A product manufacturing method comprising the steps of:
forming a pattern of a resin on a substrate using an imprint apparatus which forms patterns in a plurality of shot regions on the substrate by repeating an imprint cycle in which a pattern is formed in one shot region on the substrate by curing a resin while an original and the resin are in contact with each other; and
processing the substrate on which the pattern is formed in the forming step,
wherein the apparatus comprises:
a detector configured to detect a mark formed on the substrate; and
a controller configured to execute overlay measurement, in which the controller causes the detector to detect the mark, and obtains an overlay error that is a shift between a pattern formed on a given layer on the substrate and a pattern newly formed on a layer on or above the given layer, between successive imprint cycles.
